(19) United States
(12) Patent Application Publication
(10) Pub. No.: US 2010/0217960 A1
(43) Pub. Date: Aug. 26, 2010

(54) Method of Performing Serial Functions in Parallel

(75) Inventor: Wally Haas, Mount Pearl (CA)

Correspondence Address: AVALON MICROELECTRONICS, INC.;ATTN: Intellectual Property, 58 Glencoe Drive, Mount Pearl, NF, A1N 4S9, CA

(73) Assignee: AVALON MICROELECTRONICS, INC., Mount Pearl (CA)

(21) Appl. No.: 12/431,781

(22) Filed: Apr. 29, 2009

Related U.S. Application Data
(60) Provisional application No. 61/154,061, filed on Feb. 20, 2009.

(51) Int. Cl. G06F 9/305

(52) U.S. Cl. 712/223; 712/E09.018

(57) ABSTRACT

A method for performing serial functions in parallel, where a datapath is divided into several independent stages, or pipeline stages, so that logical functions can be implemented in each pipeline stage concurrently. In an illustrative embodiment of the invention, a pipelined logic tree is described. This method allows for n-bits to be input to the system and n-bits to output from the system concurrently.

### CROSS-REFERENCE TO RELATED APPLICATIONS

Claims priority to U.S. Provisional Application No. 61/154,061, “Pipelined Logic Tree,” originally filed Feb. 20, 2009.

### STATEMENT REGARDING FEDERALLY SPONSORED RESEARCH OR DEVELOPMENT

N/A

### REFERENCE TO SEQUENCE LISTING, A TABLE, OR A COMPUTER PROGRAM LISTING COMPACT DICS APPENDIX

N/A

### BACKGROUND OF THE INVENTION

1. Technical Field of the Invention

The present invention discloses a method of performing serial functions in parallel.

2. Background of the Invention

Integrated Circuit (IC) semiconductor devices, such as Field Programmable Gate Arrays (FPGAs) and Application Specific Integrated Circuits (ASICs) are employed to implement logical functions, such as implementing combinational logic elements or combinatorial logic elements to reduce a number of bits (n) into a smaller number of bits (<n). Such logical functions can include the linear logic functions XOR, NOR, AND, NAND, OR and NOR. When a serial bit stream of an arbitrary n-bit length is used to perform serial functions, such as implementing any linear logic function, each bit depends upon the previous bit, or each function depends upon the previous function. For example, FIG. 1 illustrates two bit streams, each comprising three bits, for illustrative purposes. Here, data is transmitted serially, so the bits are acted upon in the order: A₀; B₀; C₀; A₁; B₁; C₁. Because the datapath is evaluated on a bit-by-bit or function-by-function basis, transmitting each bit stream is problematic; with each bit (for example, A₁) depending upon the previous bit (i.e., C₀), or each function depending upon the previous function (where again, location A₁ would depend upon location C₀), a large amount of memory is required to store the data, and transmission speeds are negatively impacted, as each bit location or function location must wait for the previous bit location or function location to be acted upon; if the result of bit/function location A₀ is determined in a first clock cycle, the result of bit/function location C₁ would not be known until a sixth clock cycle, as C₁ is dependent upon each of the five previous bit locations for its result.

### SUMMARY OF THE INVENTION

The present invention increases the transmission rate of a serial datapath by dividing the datapath into several smaller independent stages, or pipeline stages, allowing the present invention to perform serial functions in a parallel manner, with serial functions occurring concurrently over the datapath's plurality of pipeline stages. Such pipeline stages include both logic and memory, and therefore this method may be utilized when a datapath, comprised of a serial equation of an arbitrary length, must be evaluated on a bit-by-bit, or on a function-by-function basis. By performing serial functions in a parallel manner, with linear logic functions occurring concurrently across two or more pipeline stages, transmission speeds are increased so that n-bits can be input to the system each clock cycle, with n-bits output from the system each clock cycle.

### DESCRIPTION OF THE DRAWINGS

FIG. 1 discloses a block diagram of two bit streams, as known in the art.

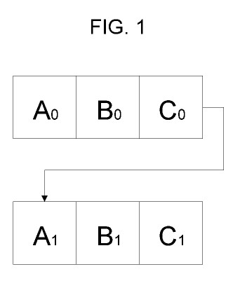

FIG. 2 discloses the pipelined logic tree of the present invention.

FIG. 3 discloses a block diagram of the circuitry elements which may implement the pipelined logic tree shown in FIG. 2.

### DETAILED DESCRIPTION OF AN ILLUSTRATIVE EMBODIMENT OF THE INVENTION

The present invention discloses a method to perform serial functions in parallel via a pipeline structure. The present invention may be utilized when a data path, comprised of a serial equation of an arbitrary length, must be evaluated on a bit-by-bit basis, or must be evaluated on a multiple bit function-by-function basis.

In an illustrative embodiment of the invention, a logic tree is executed via the pipeline structure. This pipelined logic tree employs an arbitrary bit stream of three bits; however, it should be noted that this three-bit bit stream is used for illustrative purposes only and is not intended to limit the scope of the invention, as any size bit stream may be accommodated. The bit stream implements the cascading function F_{X}, where each bit, or each multiple-bit function, depends upon the previous bit. However, by utilizing a pipeline structure to implement multiple serial functions in parallel, the present invention can both input n-bits into the system each clock cycle and output n-bits from the system each clock cycle.

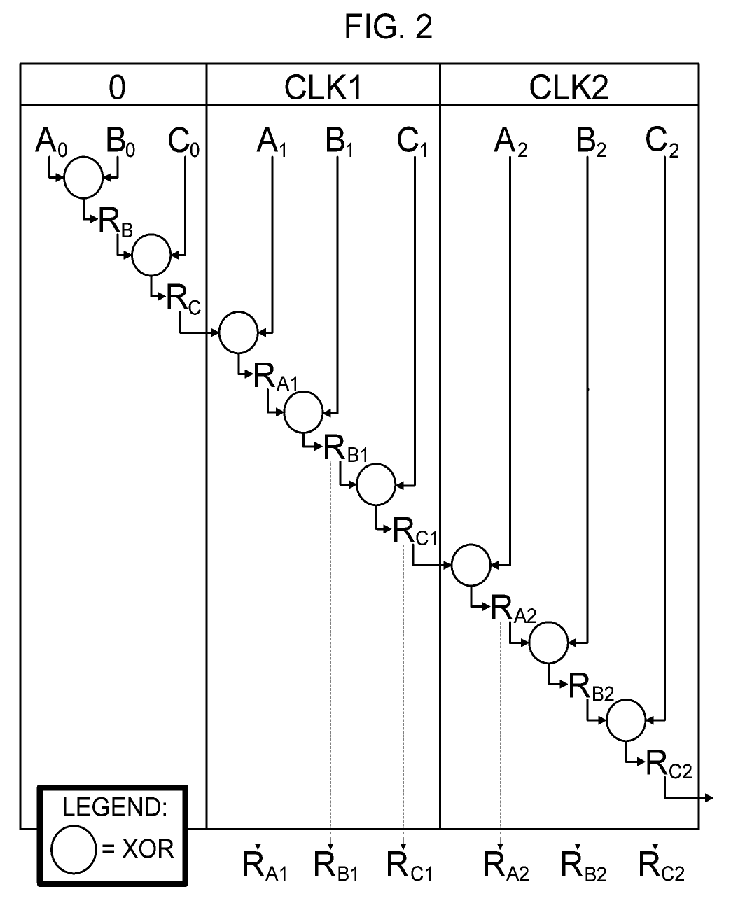

As shown in FIG. 2, nine bits from three bit streams of three-bits (the first bit stream comprising A₀, B₀, C₀, the second bit stream comprising A₁, B₁, C₁, and the third bit stream comprising A₂, B₂, C₂) are transmitted in a parallel fashion using the arbitrary linear logic function Exclusive-Or (XOR). It should be noted that the XOR function is chosen for illustrative purposes only, as any linear logic function can be accommodated. As illustrated, the pipelined logic tree begins with an “initialization phase” (0), in which three bits, A₀, B₀ and C₀ are logically combined through Exclusive-Or (XOR) gates: A₀ XOR B₀ produces the result R_{B} (i.e., the Result of B) and R_{B} XOR C₀ produces the result R_{C} (i.e., the Result of C).

The value of the result R_{C}, as the initialization result, is transmitted into the bit stream of the first clock cycle (CLK1),which initiates a “normal phase,” where the same pipeline structure is employed: R_{C} XOR A₁ produces the result R_{A1}; R_{A1} XOR B₁ produces the result R_{B1}; and R_{B1} XOR C₁ produces the result R_{C1}. Similarly, the value of the result R_{C1}, as the value of the final result of CLK1, is transmitted to the bit stream of the second clock cycle (CLK2), where the pipeline structure is again employed: R_{C1} XOR A₂ produces the result R_{A2}; R_{A2} XOR B₂ produces the function R_{B2}; R_{B2} XOR C₂ produces the function R_{C2}, which is transmitted on to the next clock cycle (not shown). This process may iterate through any number of clock cycles.

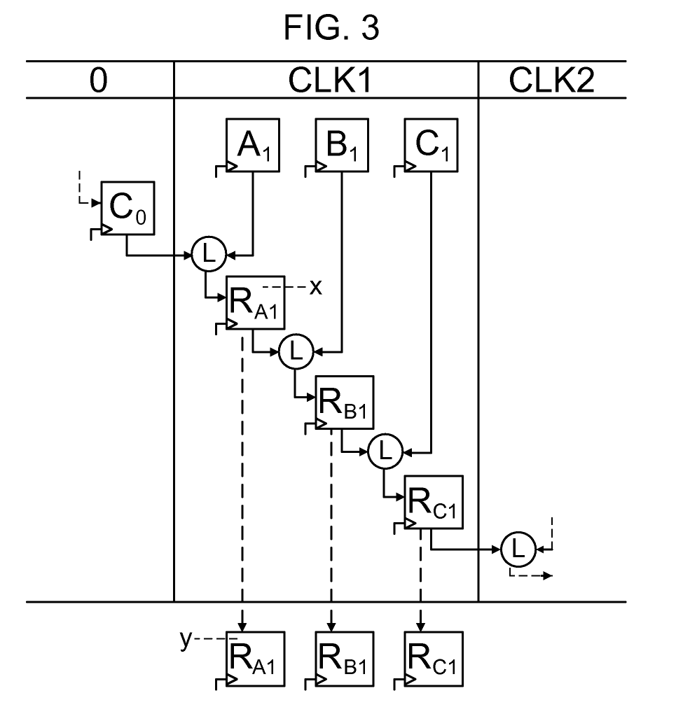

As illustrated in FIG. 3, the result produced by each bit location is stored in a memory element; in the illustrative embodiment of the invention, three results are produced each clock cycle. In the three-bit bit stream, the three stored results are stored in a first memory element, and are then output from the system into subsequent memory elements. For example, in FIG. 3, C₀ and A₁ enter a logic element (L) and the resulting result, R_{A1}, is stored in memory element (x) before being output from the system into memory element (y). As illustrated in FIG. 2, by saving the results from each clock cycle in a first memory element, the present invention ensures that for this illustrative three-bit bit stream, three bits are input to the system per clock cycle and three bits are output from the system, per clock cycle: as shown, results R_{A1}, R_{B1} and R_{C1} are output in CLK 1; R_{A2}, R_{B2} and R_{C2} are output in CLK 2; etc. In other words, by utilizing this pipeline structure to perform serial functions in parallel, n-bits can be input to the system and n-bits can be output from the system concurrently. This increases the transmission speed of the data path, as by performing operations concurrently across a number of pipeline stages, in a parallel manner, serial functions can be performed without the limitation of requiring the value of the previous bit, which requires the value of the second previous bit, and so on, thereby reducing the number of clock cycles required to output the results from the data path.

I claim:

1. A method for performing serial functions in parallel, comprising:
(a) a datapath comprising n-bits, wherein said datapath is divided into a plurality of independent datapath stages, said plurality of independent datapath stages each comprising p-bits, said plurality of independent datapath stages further comprising at least one of a plurality of logic elements and at least one of a plurality of first memory elements,
(b) a plurality of logical functions, wherein said plurality of logical functions are concurrently performed by said logic elements of said plurality of independent datapath stages
(c) a plurality of result values produced from each of said plurality of logical functions, wherein each of said result values are stored in one of said plurality of first memory elements
(d) a plurality of second memory elements, wherein said result values stored in each of said plurality of first memory elements are output from the system into each of said plurality of second memory elements.

2. The method of claim 1, wherein said plurality of independent datapath stages are a plurality of pipeline stages.

3. The method of claim 1, wherein said plurality of logic elements, said plurality of first memory elements, and said plurality of second memory elements form a logic tree.
